(19) United States
(12) Patent Application Publication
(10) Pub. No.: US 2023/0021002 A1
(43) Pub. Date: Jan. 19, 2023

(54) LIGHT-EMITTING DEVICE, BACKLIGHT UNIT FOR A DISPLAY DEVICE, AND DISPLAY DEVICE

(71) Applicant: VESTEL ELEKTRONIK SANAYI VE TICARET A.S., Manisa (TR)

(72) Inventor: Günes AYDINDOGAN, Manisa (TR)

(73) Assignee: VESTEL ELEKTRONIK SANAYI VE TICARET A.S., Manisa (TR)

(21) Appl. No.: 17/782,803

(22) PCT Filed: Dec. 5, 2019
(86) PCT No.: PCT/EP2019/083822

§ 371 Date: Jun. 6, 2022

(51) Int. Cl. G02F 1/13357; G02B 5/20; G02B 5/18; G02B 5/00; G02B 1/00

(52) U.S. Cl. CPC G02F 1/133606; G02B 5/206; G02B 5/1866; G02B 5/008; G02B 1/002; G02B 2207/101

(57) ABSTRACT

The present disclosure relates to a light-emitting device (100), comprising a dielectric layer (110) including a plurality of first quantum dots (112) embedded therein, wherein the plurality of first quantum dots (112) is configured to emit light of a first color; and a metamaterial structure (120) embedded in the dielectric layer (110), wherein the metamaterial structure (120) is configured to convert at least a portion of an energy released by the plurality of first quantum dots into surface plasmons.

### FIELD

Embodiments of the present disclosure relate to a light-emitting device, a backlight unit having the light-emitting device, and a display device having the light-emitting device and/or the backlight unit. Embodiments of the present disclosure particularly relate to QLED display panels which employ quantum dot technology in the provision of backlight.

### BACKGROUND

Display devices, such as liquid crystal displays (LCDs), are commonly used for applications such as computer and television monitors, cell phone displays, personal digital assistants (PDAs) and an increasing number of other devices. A liquid crystal display is a flat-panel display which uses light-modulating properties of liquid crystals in combination with a pair of polarizers. Since the liquid crystals do not emit light, a backlight unit is used to generate color images.

The demand for larger displays has created a need for new display structures which can provide a superior image quality while an energy consumption of the displays is reasonably low. In particular, in order to provide a superior image quality, the backlight unit of a liquid crystal display should be able to produce white light with a high luminance and a relatively low energy consumption.

In view of the above, new light-emitting devices, backlight units having the light-emitting device, and display devices having the light-emitting device and/or the backlight unit, that overcome at least some of the problems in the art are beneficial.

### SUMMARY

In light of the above, a light-emitting device, a backlight unit having the light-emitting device, and a display device having the light-emitting device and/or the backlight unit are provided.

It is an object of the present disclosure to increase a luminance of a light-emitting device. It is another object of the present disclosure to minimize or decrease an energy consumption of a light-emitting device, and in particular a backlight unit of a display device.

Further aspects, benefits, and features of the present disclosure are apparent from the claims, the description, and the accompanying drawings.

The objects are solved by the features of the independent claims. Preferred embodiments are given in the dependent claims.

According to an independent aspect of the present disclosure, a light-emitting device is provided. The light-emitting device includes a dielectric layer having a plurality of first quantum dots embedded therein, wherein the plurality of first quantum dots is configured to emit light of a first color; and a metamaterial structure embedded in the dielectric layer, wherein the metamaterial structure is configured to convert at least a portion of an energy released by the plurality of first quantum dots into surface plasmons. The surface plasmons are then converted to the light of the first color. In other words, the green photons are “encrypted” as surface plasmons.

According to another independent aspect of the present disclosure, a backlight unit, in particular for a display device such as an LCD device, is provided. The backlight unit includes a light-emitting device according to the embodiments of the present disclosure; and a light source configured to emit light of a third color.

According to another independent aspect of the present disclosure, a display device, in particular an LCD device, is provided. The display device includes a display panel configured to display an image; and the light-emitting device and/or the backlight unit according to the embodiments of the present disclosure.

According to another independent aspect of the present disclosure, a method of manufacturing a light-emitting device is provided. The method includes forming a dielectric layer having a plurality of first quantum dots embedded therein, wherein the plurality of first quantum dots is configured to emit light of a first color; and embedding a metamaterial structure in the dielectric layer, wherein the metamaterial structure is configured to convert at least a portion of an energy released by the plurality of first quantum dots into surface plasmons.

Embodiments are also directed at devices/apparatuses for carrying out the disclosed method and include device/apparatus parts for performing each described method aspect. These method aspects may be performed by way of hardware components, a computer programmed by appropriate software, by any combination of the two or in any other manner.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic view of a light-emitting device according to embodiments described herein;

FIG. 2 illustrates a color conversion according to embodiments described herein;

FIG. 3 shows a schematic top view of a metamaterial structure according to embodiments described herein;

FIG. 4 shows a schematic perspective view of a metamaterial structure according to embodiments described herein;

FIG. 5 shows a schematic perspective view of a metamaterial structure having a plurality of unit cells according to embodiments described herein;

FIG. 6 shows a schematic view of a display device according to embodiments described herein; and

FIG. 7 shows a flowchart of a method of manufacturing a light-emitting device according to embodiments described herein.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

A flat panel display may include a liquid crystal (LC) cell and a backlight unit. The backlight unit generates uniform white light having suitable color coordinates and which is directed to the LC cell. One option to obtain white light is to arrange a yellow phosphor layer on top of a blue LED chip. In this structure, some of the blue light is converted to yellow light, which is a superposition of red and green. The combination of the yellow light emitted by the yellow phosphor layer and the original blue light results is white light.

Another option to obtain white light is to use quantum dots or quantum wells. For example, quantum dots emitting green light and quantum dots emitting red light may replace the yellow phosphor as the color converting material. The quantum dots (or nanoparticles having the quantum dots) are mixed into a polymer matrix homogeneously. Therefore, a distribution of the quantum dots inside the composition is arbitrary.

Such quantum dots in a polymer matrix may have a low quantum efficiency due to a reabsorption of the emitted green light by the red quantum dots. Since the absorption spectrum of the red quantum dots includes the green region in the visible spectrum, light emitted by the green quantum dots is reabsorbed and reemitted by the red quantum dots as red light, thereby decreasing the luminous efficiency and the green component in the resulting white light, and thus the color gamut.

The embodiments of the present disclosure can overcome the above drawbacks by embedding the metamaterial structure in the dielectric layer, wherein the metamaterial structure is configured to convert an energy corresponding to a particular color, such as green, into surface plasmons. Thereby, a substantial number of photons e.g. in the green region is converted to surface plasmons, whereby the reabsorption by the red quantum dots is reduced or even avoided. In other words, the embodiments of the present disclosure “encrypt” green photons as surface plasmons to avoid an exposure to the red quantum dots. This increases the luminous efficiency. Further, an energy consumption of the light-emitting device can be minimized or decreased.

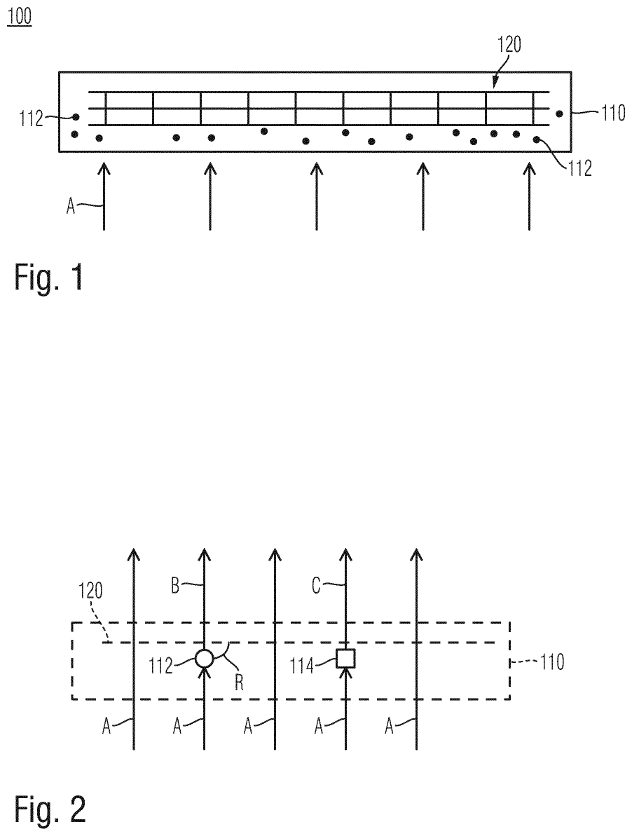

FIG. 1 shows a schematic view of a light-emitting device 100 according to embodiments described herein. The light-emitting device 100 can be included in a backlight unit of a display device, such as an LCD device.

The light-emitting device 100 includes a dielectric layer 110 having a plurality of first quantum dots 112 embedded therein, wherein the plurality of first quantum dots 112 is configured to emit light of a first color; and a metamaterial structure 120 embedded in the dielectric layer 110, wherein the metamaterial structure 120 is configured to convert at least a portion of an energy released by the plurality of first quantum dots into surface plasmons via a resonance path R. The surface plasmons are then converted to the light of the first color, such as green light, which is then emitted by the light-emitting device 100.

The dielectric layer 110 may also be referred to as “color conversion layer” or “color conversion film”.

Accordingly, the photons of the first color, such as green photons, which are emitted by the first quantum dots, are “encrypted” as surface plasmons on the metamaterial structure to prevent a reabsorption thereof by other quantum dots. For example, a hyperbolical metamaterial structure, which has a fishnet geometry, may act as a host for the surface plasmon excitation that couples with the energy/photons emitted from the first quantum dots.

In more detail, electrons and holes can combine with each other and release energy in the form of light, heat or surface plasmons. The energy released from the combination of electrons and holes in the first quantum dots 112 of the dielectric layer 110 couples to the surface plasmon mode. In other words, the energy released from the combination of carriers in the first quantum dots 112 is converted to the surface plasmons and (simultaneously) the energy of the surface plasmons is converted to the light of the first color.

Since the surface plasmons have a high energy state density, the surface plasmons couple with the first quantum dots 112 at a faster rate than the carriers releasing energy in the form of heat. Accordingly, the coupling mechanism of the surface plasmons allows the carriers to release energy in the form of light via a fast path. The energy released in the form of heat can be reduced, and the light-emitting efficiency of the light-emitting device can be enhanced.

According to some embodiments, which can be combined with other embodiments described herein, the dielectric layer 110 includes a polymer material. The metamaterial structure 120 and the plurality of first quantum dots 112 may be embedded inside of the polymer material. Accordingly, the metamaterial structure may be positioned closer to a light source on which the light-emitting device is arranged, thereby further increasing a light-emitting efficiency of the light-emitting device 100. The dielectric layer may be a high index dielectric such as TiO₂ or SiN.

In some implementations, the first color is a green color. In particular, the first quantum dots 112 can be quantum dots configured to emit green light, i.e., green quantum dots. The first color may correspond to, or be in, a wavelength range of about 480 nm to about 600 nm. The green wavelengths are likely to be reabsorbed by red quantum dots. Thus, a light-emitting efficiency of the light-emitting device 100 can be enhanced because the reabsorption of the emitted green photons can be prevented by a conversion to surface plasmons.

According to some embodiments, the dielectric layer 110 has a plurality of second quantum dots 114 embedded therein. The plurality of second quantum dots 114 is configured to emit light of a second color different from the first color. In some implementations, the second color is a red color.

The metamaterial structure 120 may be configured such that the light or energy of the second color is not converted into surface plasmons. In particular, the metamaterial structure 120 may be configured such that red wavelengths of the plurality of second quantum dots 114 do not exhibit a surface plasmon resonance. Thus, a color gamut of the light-emitting device 100 can be improved.

According to some embodiments, which can be combined with other embodiments described herein, the plurality of first quantum dots 112 (e.g. green quantum dots) and/or the plurality of second quantum dots 114 (e.g. red quantum dots) may have a size of less than 100 nm, specifically less than 50 nm, and more specifically less than 10 nm.

Further, the plurality of first quantum dots 112 (e.g. green quantum dots) and/or the plurality of second quantum dots 114 (e.g. red quantum dots) may exhibit semiconductor properties. Thus, the plurality of first quantum dots 112 and/or the plurality of second quantum dots 114 are particularly suitable for use in a backlight unit of a display device.

FIG. 2 illustrates a color conversion using a light-emitting device to the embodiments described herein.

The light-emitting device has a plurality of first quantum dots 112 and a plurality of second quantum dots 114. The first quantum dots 112 may be green quantum dots, and the second quantum dots 114 may be red quantum dots. Although the example of FIG. 2 shows individual quantum dots, it is to be understood that “larger” pieces of a quantum dot material, such as nanocrystals, may be dispersed and embedded in the dielectric layer 110. Each of the larger pieces of the quantum dot material may have multiple quantum dots.

A backlight unit (not shown) may provide background light A. For example, the backlight unit may have blue LEDs. In other words, the background light A may be blue light. The first quantum dots 112 convert at least a portion of the blue background light A into surface plasmons at the metamaterial structure 120. In particular, the energy released from the combination of carriers in the first quantum dots 112 is converted to the surface plasmons and simultaneously the energy of the surface plasmons is converted to green light B. A reabsorption of the emitted green photons can be prevented by the conversion to surface plasmons.

Further, the second quantum dots 114 convert at least a portion of the blue background light A into red light C. The blue light A which is transmitted through the light-emitting device without conversion, the green light B provided by the first quantum dots 112 and the conversion into surface plasmons, and the red light C emitted by the second quantum dots 114 are superposed and form white light. The white light can be used as a backlight for an LCD panel.

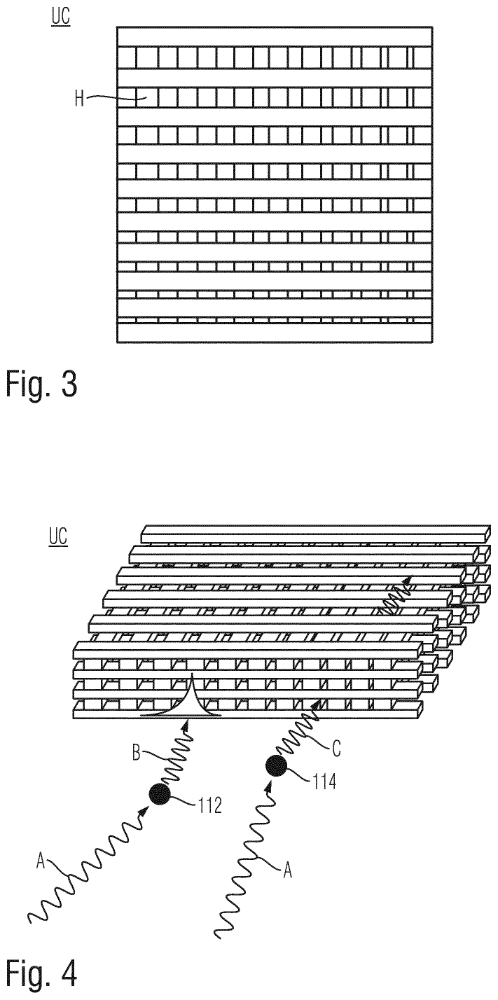

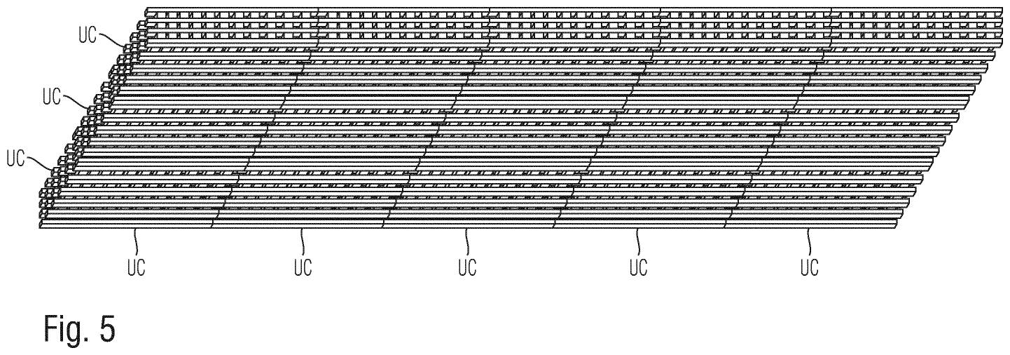

FIG. 3 shows a schematic top view of a unit cell UC of a metamaterial structure according to embodiments described herein. FIG. 4 shows a schematic perspective view of a unit cell UC of the metamaterial structure according to embodiments described herein. FIG. 5 shows a schematic perspective view of a metamaterial structure having a plurality of unit cells UC according to embodiments described herein.

The term “metamaterial structure” as used throughout the present application relates to artificial structures that cannot be found in nature. Metamaterials consist of periodic metal and/or dielectric components which allow tailoring the electric permittivity and magnetic permeability μ. Thereby, negative refraction, perfect lenses, and electromagnetically induced transparency can be provided.

Metamaterials when combined with dielectric materials allow a propagation of surface plasmons. Surface plasmons are collective oscillations of electrons at a metal/dielectric interface. These oscillations form a wave-like behavior and the wavelength of this optical component is less than the wavelength of the photons. Therefore, light can propagate faster than it propagates on ordinary materials. Besides the higher propagation speed, surface plasmons carry higher energy than photons due to their higher momentum, and they are less effected by dissipative media. Therefore, the surface plasmon-photon coupling can increase the luminous efficiency of a backlight unit.

According to some embodiments, which can be combined with other embodiments disclosed herein, the metamaterial structure has a multilayer structure. In other words, the metamaterial structure may have a plurality of layers stacked on top of each other. In some implementations, each layer of the multilayer structure may be configured as a respective grating.

The term “grating” as used throughout the present disclosure refers to essentially parallel lines or bars of a material, as it is illustrated in FIGS. 3 to 5. The lines or bars of two adjacent layers may be essentially perpendicular to each other.

The term “essentially parallel” relates to an essentially parallel orientation e.g. of the lines or bars of the grating, wherein a deviation of a few degrees, e.g. up to 1° or even up to 5°, from an exact parallel orientation is still considered as “essentially parallel”. Likewise, the term “essentially perpendicular” relates to an essentially perpendicular orientation e.g. of the lines or bars of the gratings of different layers, wherein a deviation of a few degrees, e.g. up to 1° or even up to 5°, from an exact perpendicular orientation is still considered as “essentially perpendicular”.

According to some embodiments, which can be combined with other embodiments disclosed herein, a spacing of the grating varies within each layer of the multilayer structure. In other words, the spacing is non-uniform within each layer. For example, the spacing may become wider along a first direction, i.e., the spacing may become smaller along a second direction opposite the first direction.

In some implementations, the metamaterial structure is a hyperbolic metamaterial structure, such as a fishnet hyperbolic metamaterial structure.

In some embodiments, the multilayer structure of the metamaterial structure provides different resonance paths configured to convert a wavelength or energy range of the first color to surface plasmons. The different resonance paths may be provided by the non-uniform spacing of the individual gratings. In particular, the resonance properties of the multilayer structure of the metamaterial structure may be adjusted by adjusting the spacing(s) of the grating(s).

The first quantum dots 112 may be in close vicinity to the metamaterial structure and an emission wavelength thereof may be close to a plasmonic resonance of the metamaterial structure. Thus, the first quantum dots 112 release their energy through direct near-field excitation of plasmonic oscillations. Therefore, the host structure, namely the metamaterial structure, has different parts, where each part excites surface plasmons of one specific wavelength e.g. between 480 nm and 600 nm (green).

The metamaterial structure is a periodic structure, wherein identical components are called unit cells. FIGS. 3 and 4 show one single unit cell, and FIG. 5 shows the metamaterial structure having multiple unit cells UC.

A size of the unit cell UC may be close to a wave vector of the surface plasmons, which is in the range of nanometers. Each unit cell US has a geometry configured to cover particular one or more wavelengths. In particular, the geometry of the unit cells UC can be configured to limit the resonance wavelengths to a range between 480 nm and 600 nm.

In an embodiment of the present disclosure, the metamaterial structure is placed inside the polymer film further away from an LED of the backlight unit, and the unit cell UC is provided by metal gratings that have different sizes suitable for this desired wavelength range. The holes H in a unit cell UC, which are defined by the gratings of the multilayer structure, are not identical. The holes may have uniformly decreasing sizes (see FIG. 3).

The metamaterial structure, and in particular the gratings, may be made of a metal material, such as gold or silver. These materials are particularly beneficial in regard to plasmonic behavior. The dielectric layer may be a high index dielectric, such as TiO₂ or SiN.

Referring to FIG. 4, the incident blue photons A are either absorbed by green or red quantum dots or propagate through the polymer film without conversion. The shape of the grating is structured so that blue and red photons are not affected. If a blue photon is absorbed by the green quantum dots 112 and emitted, it can either be reabsorbed by a red quantum dot 114 or excite a surface plasmon on the metamaterial structure and transfer energy to the surface plasmon as shown in FIG. 4. An efficiency is directly proportional to the quantum dot concentration and the number of metamaterial layers.

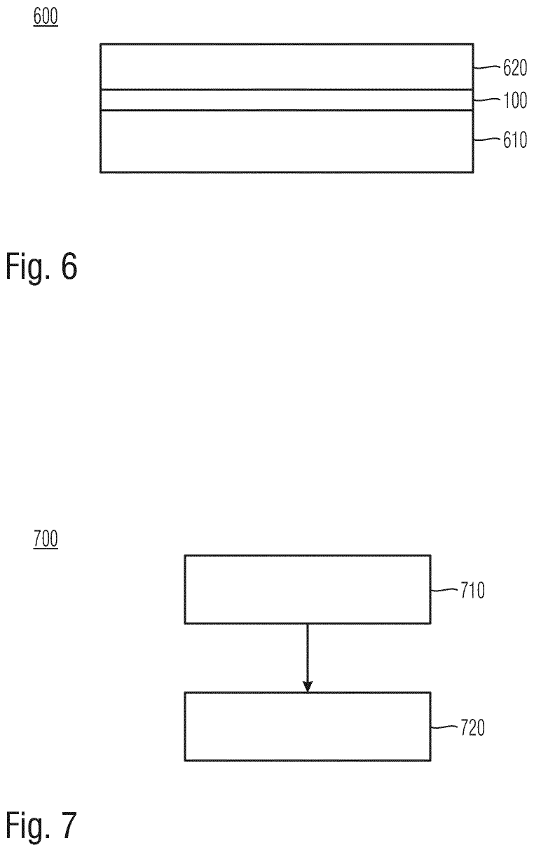

FIG. 6 shows a schematic view of a display device 600 according to embodiments described herein. The display device may be an LCD device.

The display device 600 includes a display panel 620, which may be a liquid crystal panel. The display device 600 further includes a light source 610 configured to emit light of a third color, such as a blue color. In some embodiments, the light source 610 may include on or more LEDs, such as blue LEDs.

The light-emitting device 110 of the present disclosure may be arranged between the display panel 620 and the light source 610 to convert the light emitted by the light source 610 into white light for the display panel 620. In particular, the light-emitting device 110 may convert blue light emitted by the light source 610 to white light.

FIG. 7 shows a flowchart of a method 700 of manufacturing a light-emitting device according to embodiments of the present disclosure.

The method 700 includes in block 710 a forming of a dielectric layer having a plurality of first quantum dots embedded therein, wherein the plurality of first quantum dots is configured to emit light of a first color; and in bock 720 an embedding of a metamaterial structure in the dielectric layer, wherein the metamaterial structure is configured to convert at least a portion of an energy released by the plurality of first quantum dots into surface plasmons.

According to the embodiments of the present disclosure, a metamaterial structure is embedded in the dielectric layer, wherein the metamaterial structure is configured to convert at least a portion of the energy released by the quantum dots of a particular color, such as green, into surface plasmons. Thereby, a substantial number of photons e.g. in the green region is converted to surface plasmons, whereby the reabsorption by the red quantum dots is reduced or even avoided. In other words, the embodiments of the present disclosure “encrypt” green photons as surface plasmons to avoid an exposure to the red quantum dots. This increases the luminous efficiency. Further, an energy consumption of the light-emitting device can be minimized or decreased.

While the foregoing is directed to embodiments of the disclosure, other and further embodiments of the disclosure may be devised without departing from the basic scope thereof, and the scope thereof is determined by the claims that follow.

1. A light-emitting device (100), comprising:
a dielectric layer (110) having a plurality of first quantum dots (112) embedded therein, wherein the plurality of first quantum dots (112) is configured to emit light of a first color; and
a metamaterial structure (120) embedded in the dielectric layer (110), wherein the metamaterial structure (120) is configured to convert at least a portion of an energy released by the plurality of first quantum dots (112) into surface plasmons.

2. The light-emitting device (100) of claim 1, wherein the first color is a green color, in particular in a wavelength range of about 480 nm to about 600 nm

3. The light-emitting device (100) of claim 1 or 2, wherein the dielectric layer (110) has a plurality of second quantum dots (114) embedded therein, wherein the plurality of second quantum dots (114) is configured to emit light of a second color different from the first color.

4. The light-emitting device (100) of claim 3, wherein the metamaterial structure (120) is configured such that the light of the second color is not converted into surface plasmons.

5. The light-emitting device (100) of claim 3 or 4, wherein the second color is a red color.

6. The light-emitting device (100) of any one of claims 1 to 5, wherein the metamaterial structure (120) has a multilayer structure.

7. The light-emitting device (100) of claim 6, wherein the multilayer structure provides different resonance paths configured to convert a wavelength range of the first color to surface plasmons.

8. The light-emitting device (100) of claim 6 or 7, wherein each layer of the multilayer structure is configured as a respective grating.

9. The light-emitting device (100) of claim 8, wherein a spacing of the grating varies within each layer of the multilayer structure.

10. The light-emitting device (100) of claim 8 or 9, wherein gratings of adjacent layers of the multilayer structure are oriented essentially perpendicular to each other.

11. The light-emitting device (100) of any one of claims 1 to 10, wherein the metamaterial structure (120) is a hyperbolic metamaterial structure, and in particular a fishnet hyperbolic metamaterial structure.

12. The light-emitting device (100) of any one of claims 1 to 11, wherein the metamaterial structure (120) includes, or is made of, a metal material, in particular gold and/or silver.

13. The light-emitting device (100) of any one of claims 1 to 12, wherein the dielectric layer (110) includes a polymer material, in particular TiO₂ and/or SiN.

14. A backlight unit, in particular for a display device, comprising:
a light-emitting device (100) of any one of claims 1 to 13; and
a light source configured (610) to emit light of a third color.

15. A display device (600), comprising:
a display panel (620) configured to display an image; and
the light-emitting device (100) of any one of claims 1 to 13 and/or the backlight unit (100, 610) of claim 14.
